(19) United States
(12) Patent Application Publication
(10) Pub. No.: US 2015/0044549 A1
(43) Pub. Date: Feb. 12, 2015

(54) Advances in electric car technology

(71) Applicant: Catalin Tutunaru, Cape Elizabeth, ME (US)

(72) Inventor: Catalin Tutunaru, Cape Elizabeth, ME (US)

(73) Assignee: H&D Electric, LLC, Baltimore, MD (US)

(21) Appl. No.: 13/999,703

(22) Filed: Mar. 14, 2014

Related U.S. Application Data
(60) Provisional application No. 61/852,482, filed on Mar. 15, 2013.

(51) Int. Cl. B60L 11/18; H01M 10/39; H01M 10/0561; H02J 7/00; H02K 1/27

(52) U.S. Cl. CPC B60L 11/1866; B60L 11/1861; H02J 7/0021; H02J 7/0054; H02K 1/27; H01M 10/0561; H01M 10/399; H01M 2220/20; H01M 2300/0048
USPC 429/188; 320/103; 310/156.12

(57) ABSTRACT

Systems for improving electric storage batteries and their use for powering vehicles.

### PRIORITY

This application claims priority from U.S. provisional application 61/852,482 filed Mar. 15, 2013 which is hereby incorporated by reference.

### FIELD AND BACKGROUND OF THE INVENTION

1. Field of the Invention

The present invention relates in general to electric cars and new technologies having application to improved electric cars, including the fields of electrical storage batteries, a novel system for providing an electrical storage with dual bank battery, with enhanced safety features, battery power management, auxiliary power generation systems and torque enhancers.

2. Background Information

The invention described and claimed herein comprises a number of advances in various technologies applicable to (but not limited to) the production and operation of electric powered cars, including a novel system for managing the charge on an electrical storage battery so as to extend its useful life between charges, a novel system for providing an electrical storage battery with enhanced safety features, and novel battery chemistry, auxiliary power generation systems and torque enhancers.

Rechargeable batteries include an anode, a cathode and a chamber within which chemicals are stored, and operate by charging and discharging. During the charging phase, current is passed through the battery's anode and cathode in order to promote a chemical reaction in the chemical storage chamber, which results in storage of power; during the discharge phase, a second chemical reaction takes place in the chemical storage chamber which results in the production of an electric current from the cathode to the anode, typically through a circuit which harnesses the electrical current to do work.

An area of recent interest has been the use of rechargeable batteries to power vehicles, using the battery to provide power in place of petroleum powered engines. To date, successful implementations have been hybrid vehicles, powered by both electrical battery powered motors and gasoline engines, with computer controlled switching between the power sources. While this can produce savings in miles per gallon of gasoline, it still produces pollution and noise and has a cost profile comparable to that of a gasoline engine powered vehicle (savings on the order of 1:2 or 1:4).

A vehicle powered solely by a battery would have lower emissions and significantly lower cost than even a hybrid vehicle. To date, designing such a system has been a challenge, with range being a limiting factor.

It is generally undesirable to fully discharge a battery. Thus only a fraction of the stored energy may be harnessed to do useful work before it is necessary to charge the battery. The greater the capturable fraction, the longer the battery can operate between recharging.

In some applications, extending this period between recharges can make the difference between a useful product and one with limited uses. For example, development of the electric car industry has been hampered by the lack of sufficient charging stations nationwide, limiting the usefulness of electric cars to applications which require a range comfortably within the distance between recharging stations. For example, if a car battery could operate 85 miles between charges [Leaf range] would be suitable for a commuter with a recharging station at home and a 25 mile one-way commute, but would not be suitable for one with a 50 mile one-way commute or for a 100 mile weekend trip.

One solution to this problem has been the creation of hybrid vehicles, such as the Toyota Prius™, which use battery power for a portion of the time but which also can be powered by gasoline if necessary.

A 100% electric vehicle, however, is preferable to a hybrid vehicle, because it is a clean air motor with no emissions, level of noise from 80 dB to 10/15 max dB. The cost factor in regards to long term savings is a crucial factor in today's age when gasoline and diesel is $3.50-$4.50 per gallon. The size of the Toyota Prius hybrid which uses a 100% electric powertrain will for 100 miles cost not to exceed $2.80. These are just a couple of reasons to have a 100% electric vehicle. To generate electric power we can use nuclear power plants and or hydro power, wind power, solar panels, or coal. This, in effect, will circumspect our dependency for imported oil. Another reason to have a 100% electric is due to its simplicity compared to a hybrid vehicle where the gas and/or diesel powered engine is more costly, uses a significant amount of metal, and a costly emission system, including catalytic. For the electric motor you do not have fuel filters, air filters, and all other accessories, which in regards to production are more costly, and will pollute the atmosphere and/or our forests [use of paper for filters].

The main focus for electric powered vehicles appears to have been on lead-acid electric cells, nickel-cadmium electric cells, nickel-hydrogen electric cells and sodium-sulfur electric cells, all of which have proved unsatisfactory. There has also been experimentation with zinc-air electric batteries, lithium ion electric batteries and proton-exchange membrane fuel electric batteries.

None of these has resulted in a practical battery for powering a vehicle, with the main challenges being efficiency and range and, especially in the case of lithium ion, the risk of fire and explosion.

In addition, rechargeable batteries include an anode, a cathode and a chamber within which chemicals are stored, all within a battery enclosure, and operate by charging and discharging. The materials used in batteries are safe while contained within the battery enclosure but pose hazards if the enclosure is compromised. For example, a typical battery contains acid and elements which are considered hazardous waste, and dangerous if they spill because of an eventual crash. Our battery is based on sodium nickel with no acid or any other hazardous elements.

In addition, while the electrical energy of a battery is typically connected to a circuit which provides for safe use of the current provided by the battery, but a short-circuit of the battery terminals poses a risk of fire or explosion with which our system it is completely void. At particular risk are batteries used in automobiles, which are subject to compromise under the extreme conditions of a collision, which may involve high energy impact or high temperatures if the gasoline in the vehicle catches fire.

### SUMMARY OF THE INVENTION

It would therefore be an advantage to provide a pure electric vehicle, capable of a range comparable to gasoline-powered vehicles.

One step in that direction would be a management system which would increase the percentage of the stored energy which could be extracted from a battery before the need for recharging. It is an object of the invention to increase the percentage of the stored energy which could be extracted from a battery before the need for recharging.

Another step in that direction would be a battery with storage capacity that would translate into a range comparable to a gasoline powered vehicle.

A feature of the invention is the subdivision of a battery into two banks of cells, connected in series and the two banks in parallel management of the charging and discharge of individual cells or groups of cells in a manner which increases the interval before the overall battery must be recharged.

Another feature of the invention is chemistry which provides increased storage compared to other batteries.

It would also be an advantage to provide an electric battery having safety features which would reduce the risk of escape of hazardous elements or fire or explosion in the event the battery is subjected to impact or high temperatures.

There are several ways in which electric battery construction may be improved to accomplish these objectives.

One feature of the invention is the use of chemicals which are not hazardous than those used in other batteries. Another feature is the packaging of the battery in two banks in a closed vacuum box which can be made out of metal or carbon fiber. The battery is split in two banks. Another feature of the invention is the connection of battery elements using a metal which melts over the normal limits of accepted temperature, thereby disconnecting the elements in the event of a temperature overload. They also disengage when the impact of a crash test is detected. This specifically avoids the overcharge of the battery and also, in case of a crash, automatically disconnects all of the elements. For example, 260V which are the result of adding more cells. Power from each cell is not to exceedbetween 2.5-3.5V, and with as much as 120 amps. This will independently not harm anybody, compared with 250V. Look at a regular car battery with 12V and 120 amps which will not cause any harm due to the low voltage.

Another feature of the invention is a battery management system designed to automatically disconnect in the event of a crash so as to prevent leaks of electricity which can ultimately harm the passengers.

It is another object of the invention to increase the resistance of an electric battery compartment to fracture.

It is another object of the invention to increase the resistance of an electric battery to compromise in the event of exposure to high temperature.

It is another object of the invention to reduce the risk of short circuit of an electric battery.

It is another object of the invention to provide regeneration of battery using a turbofan, thereby increasing the life of a battery between charges.

A vehicle incorporating many of the features described herein has been manufactured and tested, as shown in FIG. 1.

A regular car can have inside of the cab up to BOOB. Very good cars and limos have between 60-SODB because of the better noise insulation. The level of the noise comes from the engine and accessories, alternator, cooling fans, exhaust system, and transmission. All those things does not exist on electric cars. A normal electric car without too much noise insulation, will have between 10-ISDB level of the noise which is very low.

The cost per 100 miles varies from state to state due to the cost per kW which is

variable. The calculation is very simple. For example, a battery which has 271V*76 Ah=28.2 KwH. In the state of Maine the cost is 0.11. 28.2*0.11=$3.10. This is the cost to fully charge a battery. With our Battery Management and powertrain, our vehicle makes a minimum 120 miles. Which if you make the proper calculation you will find a cost of approximately of $2.80 per 100 miles. Again, Irepeat, that the cost of electricity varies from state to state.

The range of unmanaged system (normal system) from 99.9 battery charge will make a range of maximum 80-90 miles. A managed system as we have, will make at least 130 miles.

The catalytic converter uses very expenses materials as platinum, palladium, inox, and some other ingredients which are not recyclable. They will need special disposal. In addition, most of them are not warrantied for more that 70K miles. Sometimes, when you drive behind the car with an expired catalyst you will have a smell of sulfur, and inhale allot of cancerogen noxis. This is a big problem because not everybody can afford to change their catalyst.

The various elements making up the invention are divided into the following categories, although many of them must interact in order to accomplish the objectives of the invention:
1. Battery management systems
2. Battery chemistry
3. Battery temperature management systems
4. Battery safety systems
5. Auxiliary regeneration systems
6. Enhanced torque motor system

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is an Electric Vehicle comparison chart.

FIG. 2 is a flow chart showing the steps carried out by the battery management controller element of the invention.

FIGS. 3 and 3A are schematics showing a two-bank battery system with banks connected in parallel and cells in series, which are controlled by MBS (smart battery management) and battery management.

FIG. 4 shows the dimensions of the dual bank battery with a novelty of a carbon fiber box and a special cooling system of two cooling fans which controls the temperature of cells and battery throughout four temperature sensors controlled by BMI which was never used in nickel sodium batteries. This system keeps a steady temperature for all cells (it does not matter where they are placed: front, center, or rear of battery).

FIGS. 5 through 10 are various views of the design of a turbo fan which is placed at the end of the tunnel design based on the venturi effect using wind to assist an alternator attached to a fan for regeneration of the battery.

FIGS. 11 through 25 are test results of wind tunnel which was used to optimize the most effective dimensions of the tunnel based on the venturi effect.

FIGS. 26 through 34 are various views of the components of the enhanced torque motor system.

FIGS. 35 through 40 provide additional disclosure.

### DESCRIPTION OF THE PREFERRED EMBODIMENT

### Battery Management System

Referring to the drawings, the invention is a novel system for managing the charge on an electrical two banks storage battery so as to extend its useful life between charges.

While illustrated with respect to use in an electric vehicle, the invention may be applied to any device requiring battery power, using the same techniques, modified in a manner which would be known to one skilled in the art.

In a typical electric powered motor vehicle, power is drawn from a battery to power the vehicle and the battery is recharged to some extent during operation using regenerative braking. Regenerative braking is not sufficient to fully recharge the battery, so periodically the battery must be connected to a source of electricity and recharged. That process typically takes from 4 to 8 hours during which time the car cannot be used for transportation.

There are special charging poles which can charge the battery in 30 minutes. Meanwhile, this will shorten the life of the battery considerably: over 30%.

Typically, once the battery has been drawn down to 20% it must be recharged because the power of the motor will go to max 40%. A delay in recharging the battery will also result.

In the system claimed herein, a battery similar in capacity is divided into two banks as shown in FIG. 3.

For simplicity, the system is illustrated with two banks. Each bank comprises a bank of one or more cells connected in series to achieve the desired voltage; optionally, multiple banks may be connected in parallel to provide the proper voltage. Meanwhile, for more than two banks the special cells must be designed because the dimensions of the battery has to be feasible to be installed in vehicles where normally the space is very tight.

The MBS (smart battery module) monitors the level of charge in each bank. For simplicity of explanation, the banks are referred to as Bank 1 and Bank 2. Initially, power is drawn from Bank 1. At the point when Bank 1 has be drawn down to 50% the MBS switches power from Bank 1 to Bank 2 (which is 100% charged), drawing power now from Bank 2. The entire recharging capacity (breaking, turbo fan, downhill, and so on) is used now to recharge Bank 1. When Bank 2 reaches 20% charge, the MBS switches the power to the motor working in parallel with both Bank 1 and Bank 2, and switches the recharging capacities to both banks until such a time that the batteries will be discharged close to 20%.

This process of monitoring and switching continues until both Banks reach the critical value, at which point the battery which is formed out of Bank 1 and Bank 2 must be completely recharged. In certain situations the MBS may switch automatically to both banks when allot of power is needed, and/or, disconnected using only one bank when the vehicle goes downhill and/or does not need to use allot of power.

The benefit of this system which was never used in battery technology is that it delays the point at which the battery reaches the critical value and thereby provides longer range for the vehicle between recharges.

In the case of an electric vehicle, this translates into greater range and therefore greater usefulness of the vehicle.

The experiments were carried out to quantify the benefit of the multiple-bank system over a prior art single-bank battery. The experimental vehicle was equipped with a braking regen system, downhill regen system, deceleration, and wind turbine regen system. In the herein attached diagram all combined regen systems can provide up to maximum 30% improvement pending to road and weather conditions. In addition, it was equipped with a DC motor, High Torque DC motor allowing 3-4× ratio gearing, lower RPM (less than 1,000) providing high mileage per kilowatt use. This motor is also a patent novelty.

One of the most part of the electrical vehicle is the battery. Such batteries are subject to extreme conditions even under normal use, and even more extreme conditions in the event of a collision.

### Battery Chemistry

An electric battery typically comprises an insulating casing, a plurality of individual cells located within said casing, a pair of external terminals for connecting the battery to the electrical motor of the vehicle, a plurality of internal connections for interconnecting the cells with each other and a connection to the external terminals. A sodium nickel battery consists of an assembly of single cells in series which in our case are in two banks. Each in the charge stage contains Sodium (common salt, in our case, sourced from Northern France) as negative electrode and Nickel Chloride as positive electrode. Sodium reacts with Nickel on discharging and the process reverses the direction of charging. Belta Alumina and Silver is used as an electrolyte which conducts sodium ions. The most important part of the cell is the ceramic which in our case has a special formula which was never used which has a special shape and determines the resistance and efficiency of the cells. The size and chemical use in our cells are designs that are completely new which make the positive electrode as a collector located inside the ceramic electrolyte tube. The negative electrode (common salt) is located between ceramic and cell case, which is also the negative pole of the cell. Those cells are designed for 258-3.2V and to work at the temperature between 240-360° C.

Our design of the cell to get the proper cell reaction is made out of 38% common salt, 20% nickel, 4% silver, 16% copper, 18% iron, 6% miscellaneous, including titanate substrate, which increases the charge density. Optimum operating temperature of 245-360° C. A suitable casing made out of carbon fiber an insulating material, SiO2 is used for efficient insulation which can be stable up to 1000° C.

In Figures, you can see bank 1 and bank 2 which is formed out of 160 cells each. Each bank has its own BMI (32 bits). The cells are in series, and the two banks are in parallel. Both of them are equipped with a BMI with a special software which coordinates the two chargers throughout a pulse-way modulated signal. This, as a result, keeps the required power outage. The MBS supervised the two banks through a special software which also coordinates the two BMis; switching from one bank to another when it is needed. The traction battery charger works with 220V from any network, or, throughout a special charging station with nominal current between 16-63 amps, and nominal voltage between 200-250 VAC (single phase) and or 380-480 VAC (three phase). This makes it possible to charge both banks in a very short period of time. The traction battery chargers can also charge the cells from all Regen system which is attached to the vehicle. The smart module (MBS) feeds continuous information to the driver display of charge status of battery, and bank one and bank two.

The battery is a unique nickel sodium battery made out of special cells which nobody has at this time. The battery is made out of cells from a unique construction: sq 5 inch×7 inch length, with a weight not to exceed 428 grams. We were able to have two banks in one battery. The cells are vertically assembled in a double walled vacuum insulated battery box in two banks, one on top of the of the other. Si02 material is used for efficient insulation which can be stable up to 1000° C. The chemistry of the cells will neutralize, if a failure occurs, because the electrolyte is damaged. A unique air cooling system with 2 designated fans controlled by BMI which also controls the two ohmic heaters, or both banks necessary to provide the operation temperature. The current batteries have one fan which circulates the cold air around the battery and the cells, and takes out the hot air on the same side; leaving the far side of the battery not being efficiently cool. With fans on each side of the battery each one evacuates the hot air on the opposite side of the cooling air; like that the cooling is more efficient and can keep all of the cells at the same temperature. In addition, this type of cooling is more efficient from a safety point of view, avoiding the temperature above 1ooooc which happens sometime in the

current batteries. Operating range of the batteries is 240° C.-370° C. As it was explained before, it will be very hard to discharge the battery completely which increases the calender life for more than 15 years, comparing with the existing ones which is a maximum of 10 years. The cycle life also is over 4500 nameplate cycles comparing with a maximum of 3000 of the existing ones. Another unique feature of the battery is that the battery box is made out of carbon fiber which provides a possibility to be sealed, protected, and also manufactured with less cost.

### Battery Temperature Management

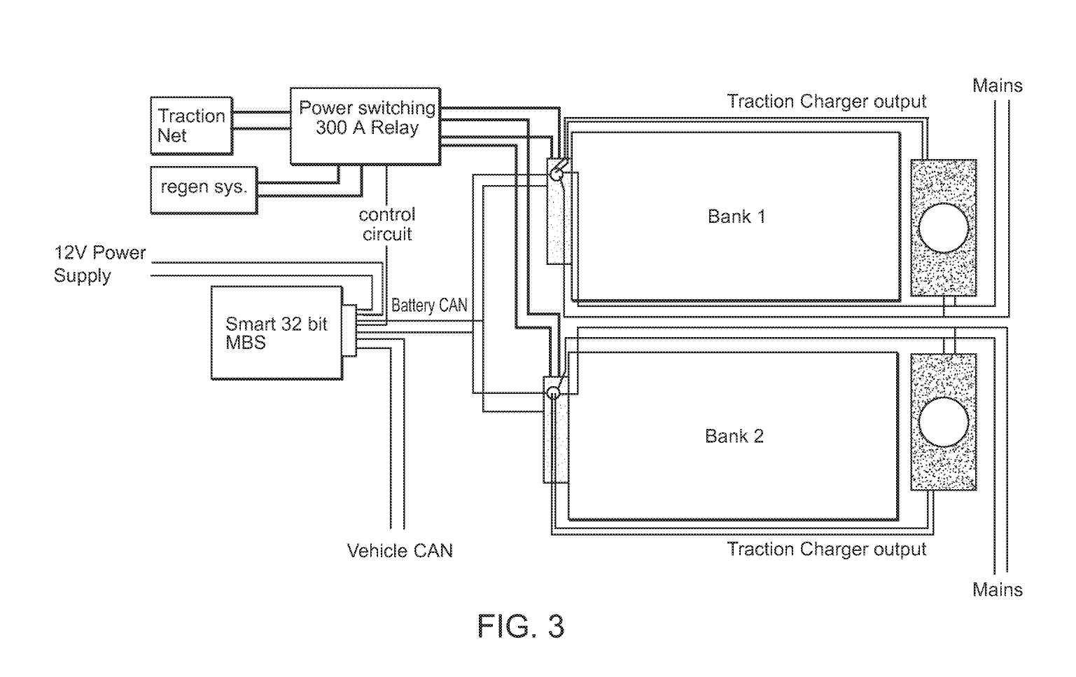

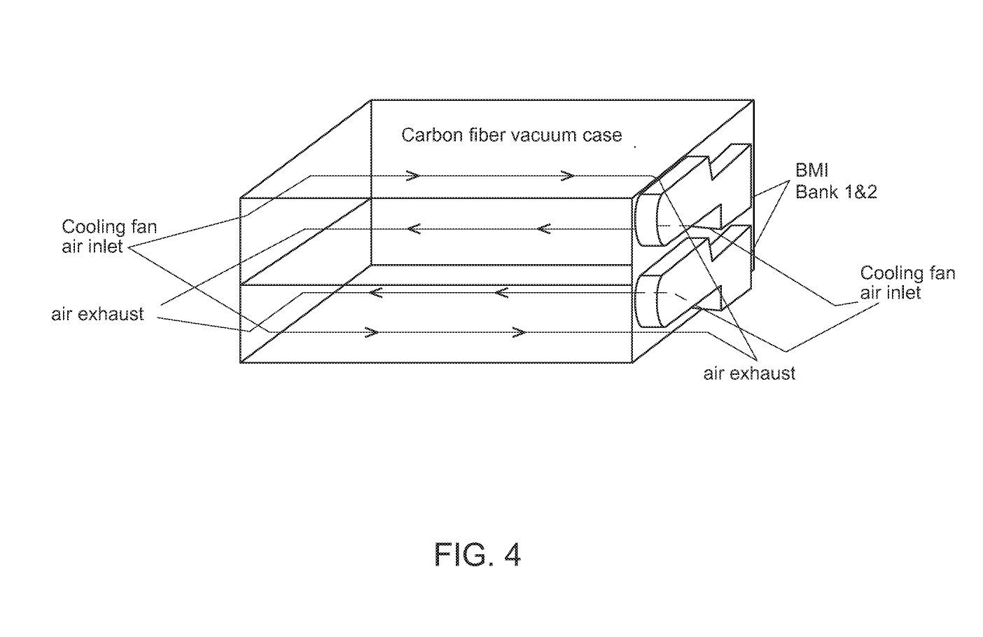

A challenge is to maintain the proper and consistent battery temperature so as to allow sufficient temperature for the battery to operate, but to keep the temperature low enough to avoid overheating or explosion. It is also desirable to maintain as even a temperature as possible within the battery so that all cells are within a proper operating range. Batteries which use a single cooling fan cannot achieve this goal. Instead, the invention uses cooling fans placed at opposite sides of the battery as shown in FIG. 4, whereby cool air flows in from two directions and produces a cooler and more uniform temperature.

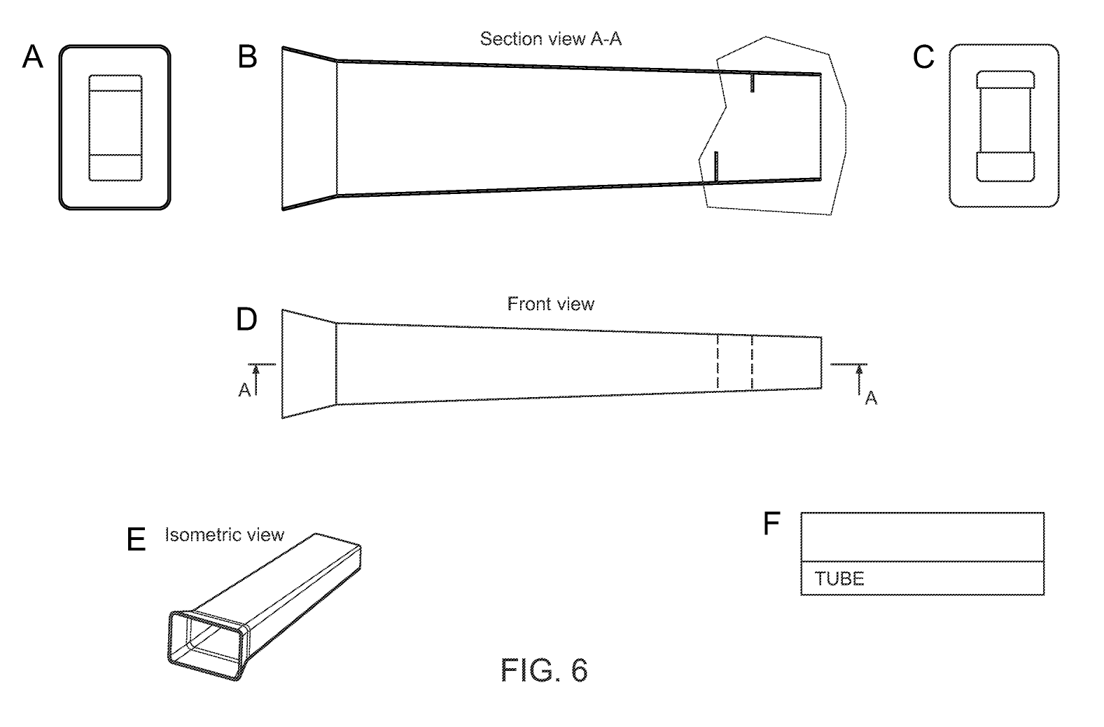

Also, to maintain the operating temperature an insulated heater is located at the top of the cell. The air is blown into cooling plates between the cells to insure that the excess heat is removed as required by the temperature sensors. Another aspect of the invention relates to regenerating a battery so as to increase the time between recharging, using an alternator attached to a Turbo Fan which is installed at the end of a tunnel based on the Venturi Effect. This tunnel is illustrated in FIG. 6, and has the front attached to the bumper, and having a length approximately 36″ and also going alongside the frame as space permits. The turbo fan is located at the end of the tunnel which is caused to rotate by the air coming from front of car through the tunnel.

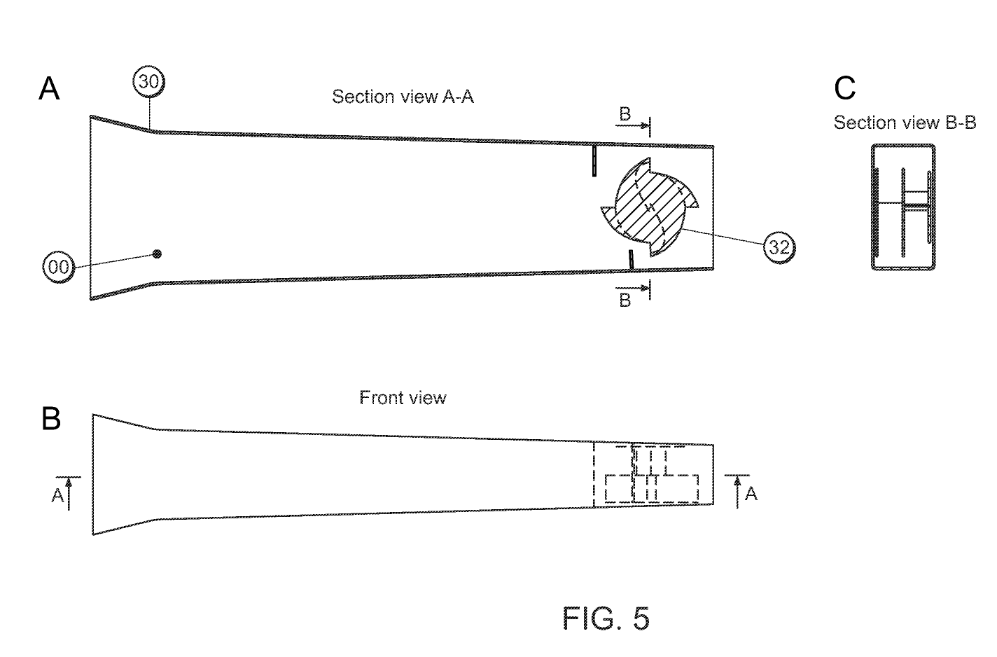

The turbo fan has a special design with three blades with pattern as per FIG. 5. Based on the test the most use of an electrical vehicle, especially in a city is between 30-50 mph. The test and the fan was done to optimize the tunnel for the pressure of the air created between these speeds. This system increases the regen electric charging output by at least 30%.

Turbo Fan based on Venturi Effect can easily improve the regen system upwards to 30%. In our studies, we consider a speed of EV between 36-40 mph which is practically the speed used in majority cases: city, villages, and other roads. We consider that our system will be implemented in the front bumper of the vehicles. Or, at least, attached to that.

We have three bumper possibilities which we tested for the following situations:

Immediately after the end of the bumper the speed is close to 50 mph. At the end of the bumper the speed is 40 mph. At the end of the tube which we designed with the length of 36 inches the speed varies between 55-60 mph. This is the solution which we chose. All above situations prove that at the end of the tunnel it is enough to rotate the turbo fan which has attached to it our hi torque electric motor which will produce enough regen electricity to increase with at least 30% the regen systems.

In regards to the drawings for the regen wind turbines {WT} the axle of the fan will be attached to a small generator. The calculated torque for a car speed between 37-40 mph is 0.2017 Nm. This particular regen system was never used. This is a new idea which gives enough regen electricity for any moving vehicle or object which can go with that speed. Everything is a new design with a special prop design in a way that the turbine can efficiently use. This can also be attached to an electric wind turbine.

took 37-40 mph as the most used speed of any electric vehicle, especially in the city and or residential area. All of the parts and components are made out of carbon fiber. This is a special patent which can charge the conventional battery used for all
vehicle accessories. Currently, this energy comes out of the main battery which lowers the range of the vehicle. Two or three of the WTs can be installed on certain vehicles. The WT is calculated in a way that does not influence the aerodynamics.

### Battery Safety Systems

Rechargeable batteries include an anode, a cathode and a chamber within which chemicals are stored, all within a battery enclosure, and operate by charging and discharging. The materials used in batteries are safe while contained within the battery enclosure but pose hazards if the enclosure is compromised. For example, a typical battery contains acid and elements which are considered hazardous waste. In addition, while the electrical energy of a battery is typically

connected to a circuit which provides for safe use of the current provided by the battery, but a short-circuit of the battery terminals poses a risk of fire or explosion. At particular risk are batteries used in automobiles, which are subject to compromise under the extreme conditions of a collision, which may involve high energy impact or high temperatures if the gasoline in the vehicle catches fire.

It would therefore be an advantage to provide an electric battery having safety features which would reduce the risk of escape of hazardous elements or fire or explosion in the event the battery is subjected to impact or high temperatures. It is an object of the invention to increase the safety of an electric battery.

It is another object of the invention to increase the resistance of an electric battery compartment to fracture. It is another object of the invention to increase the resistance of an electric battery to compromise in the event of exposure to high temperature. It is another object of the invention to reduce the risk of short circuit of an electric battery.

One of the most common uses of electrical batteries subject to the above risks is the automotive battery. Such batteries are subject to extreme conditions even under normal use, and even more extreme conditions in the event of a collision.

As examples of other applications, the invention could also be used to improve the safety of batteries used in other vehicles, airplanes, spacecraft, locomotives or ships, and to non-vehicle applications such as batteries to start backup or emergency generators, used to provide storage for off-grid applications such as solar or windmill power,

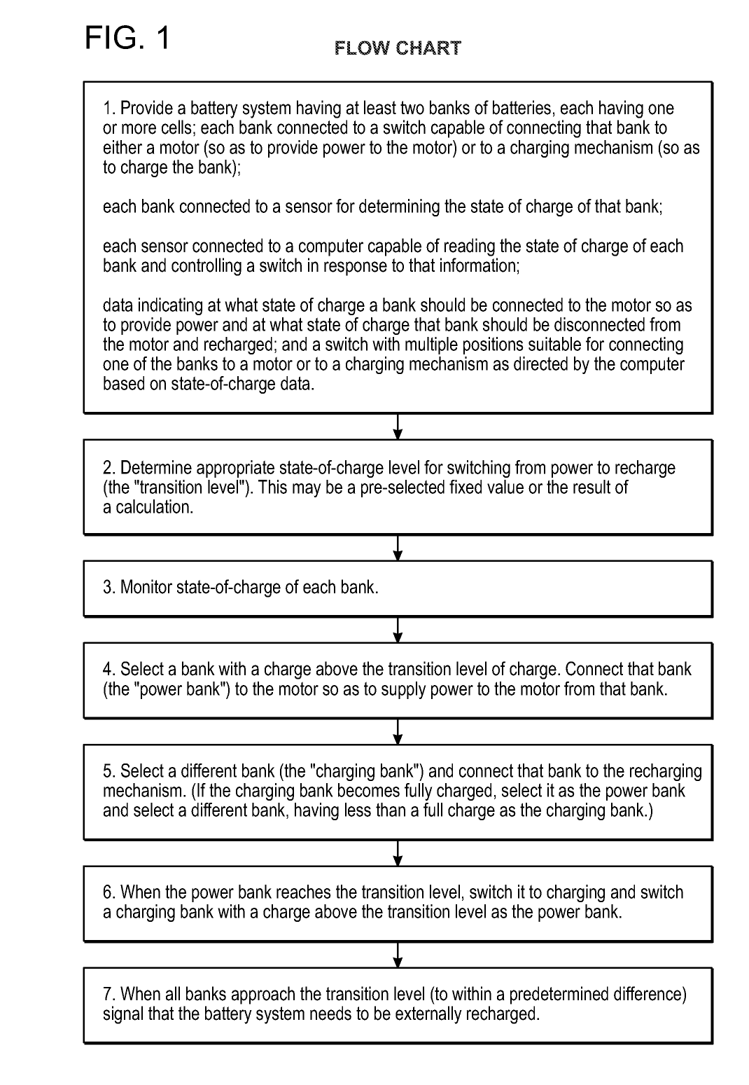

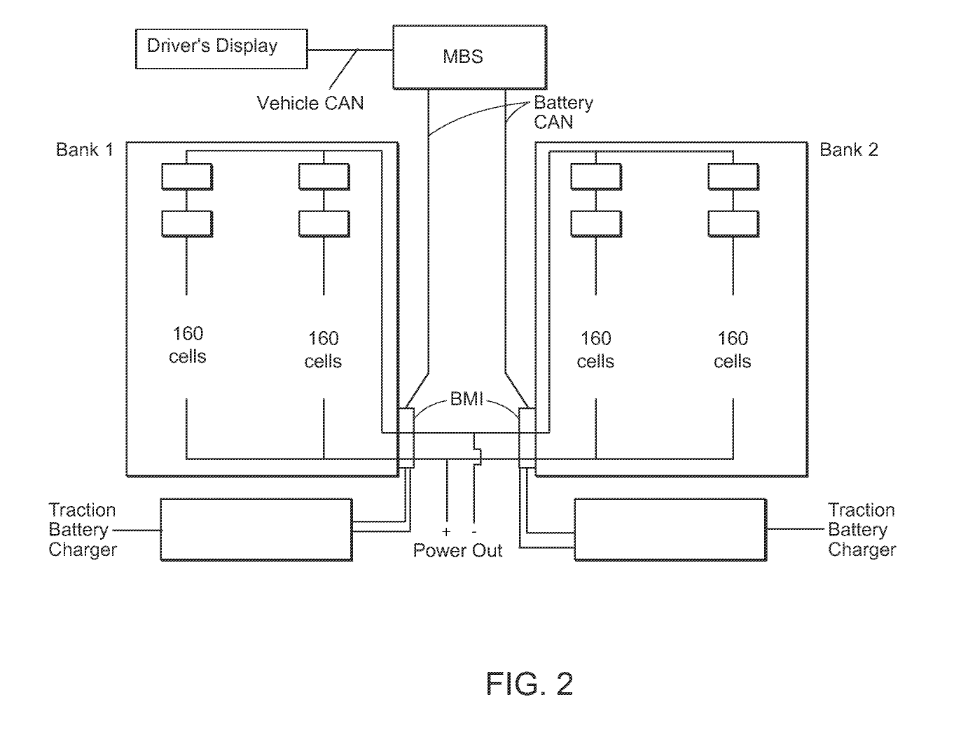

Our battery was tested static with a vertical drop from a 12.2 m tall tower. The battery was fully charged and with a temperature of 350° C., and 250V. This represents the penetration tests which end up with a drop of the battery in a crash barrier as per herein attached picture. The battery and battery elements did not spill, or either lose electric power, which could have ultimately endangered the passengers. A very thin non-harmful smoke results as a sodium escaping from cell rupture in the impact. After 1.5 hrs no smoke, fumes, or other leaks. This shows that the battery management and battery safety features work out in an eventual crash of the vehicle. The battery did not suffer spillage of its internal components or its large quantity of its regens. The safety features of the battery was also tested inside of the car which was crashed side, frontal, and rear. After each test a roll over. The vehicle was measured before every test and immediately after the crash (including after the roll-over). No spillage or leaks of high temperature or electricity was found. See FIG. 1.

Another safety risk addressed by the invention is overheating, which plagues conventional batteries. This risk is mitigated by providing a dual-fan cooling system. While other batteries use one fan which circulates the cold air around the battery and the cells, and takes out the hot air on the same side, this leaves the far side of the battery not being efficiently cooled. The invention solves this problem by providing two fans, one on each side of the battery, as shown in FIG. 4, so that each one evacuates the hot air on the opposite side of the cooling air. This more efficient cooling helps keep the operating temperature at a safe level, and also helps keep all cells at comparable temperatures which improves battery management. The battery was installed in vehicles which work in extreme use at temperatures of up to 120° F. and −20° F. with no lose of power or eventual explosions.

### Regarding the Level of Noise:

A regular car can have inside of the cab up to BOOB. Very good cars and limos have between 60-SODB because of the better noise insulation. The level of the noise comes from the engine and accessories, alternator, cooling fans, exhaust system, and transmission. All those things does not exist on electric cars. A normal electric car without too much noise insulation, will have between 10-ISDB level of the noise which is very low.

The cost per 100 miles varies from state to state due to the cost per kW which is variable. The calculation is very simple. For example, a battery which has 271V*76 Ah=28.2 KwH. In the state of Maine the cost is 0.11. 28.2*0.11=$3.10. This is the cost to fully charge a battery. With our Battery Management and powertrain, our vehicle makes a minimum 120 miles. Which if you make the proper calculation you will find a cost of approximately of $2.80 per 100 miles. Again, i repeat, that the cost of electricity varies from state to state.

The range of unmanaged system (normal system) from 99.9 battery charge will make a range of maximum 80-90 miles. A managed system as we have, will make at least 130 miles.

The catalytic converter uses very expenses materials as platinum, palladium, inox, and some other ingredients which are not recyclable. They will need special disposal. In addition, most of them are not warranted for more that 70K miles. Sometimes, when you drive behind the car with an expired catalyst you will have a smell of sulfur, and inhale allot of cancerogen noxis. This is a big problem because not everybody can afford to change their catalyst.

### Auxiliary Regeneration Systems

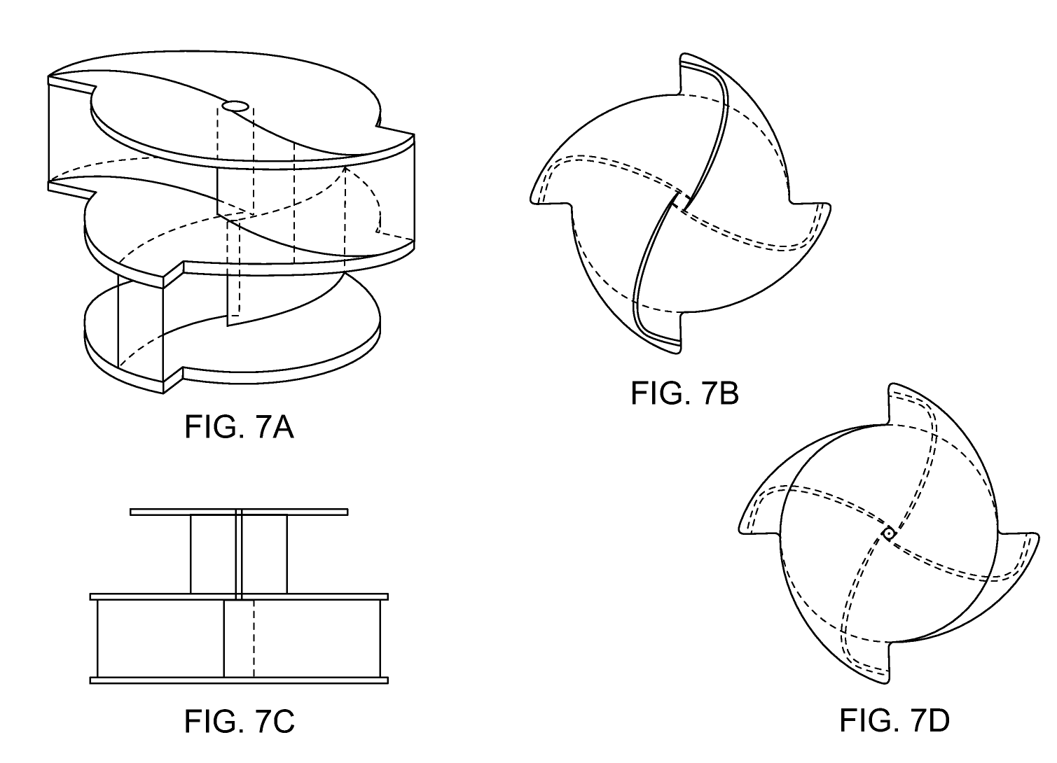

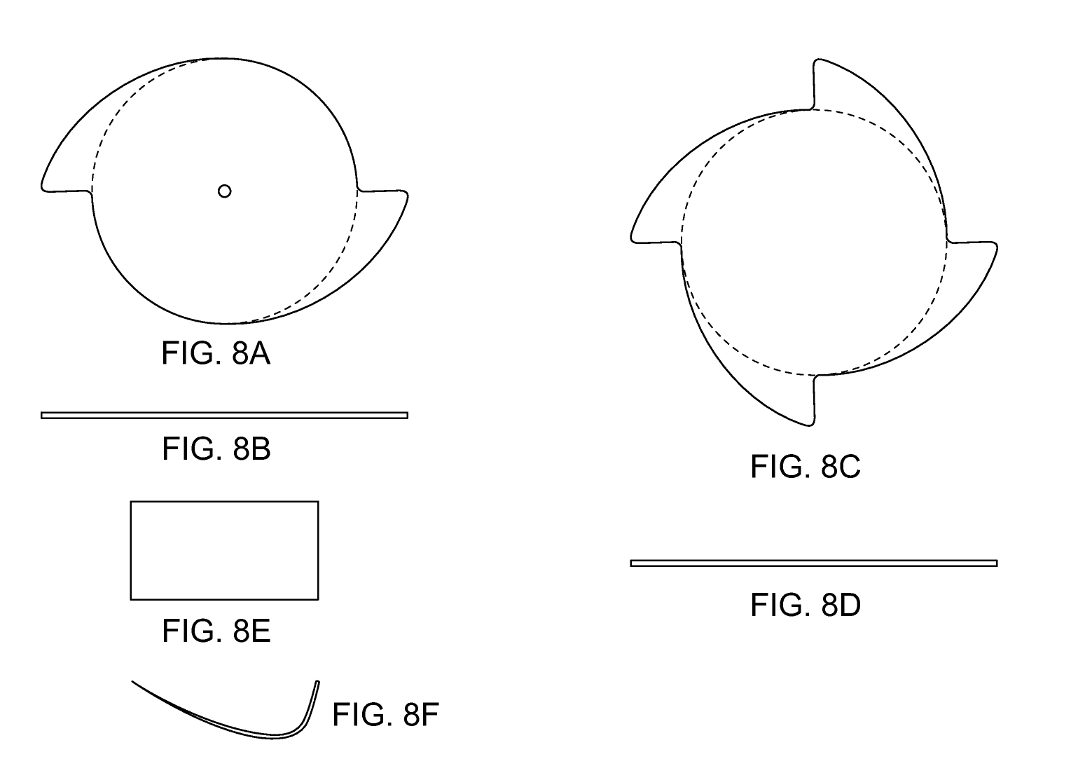

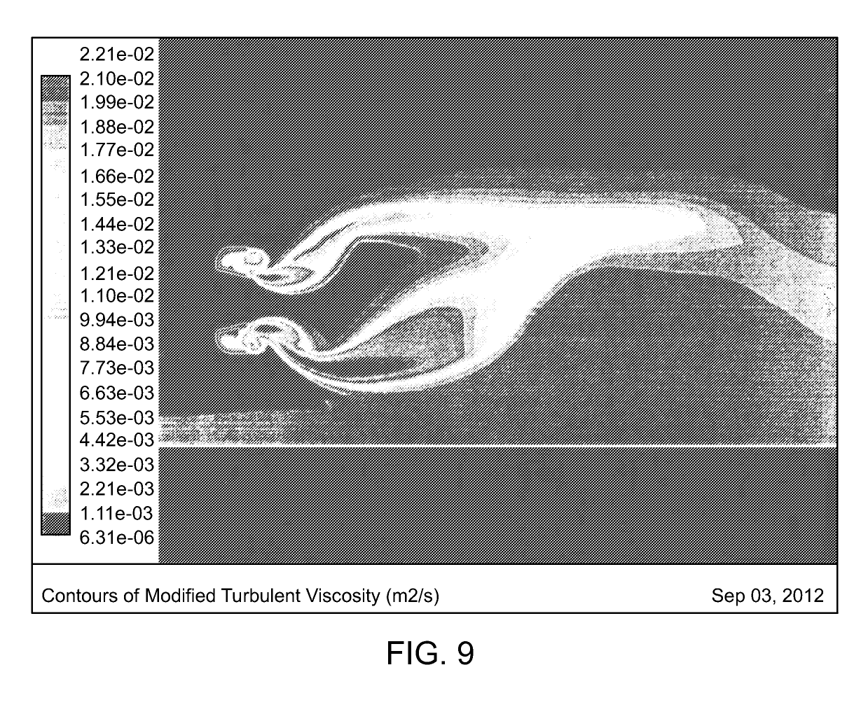

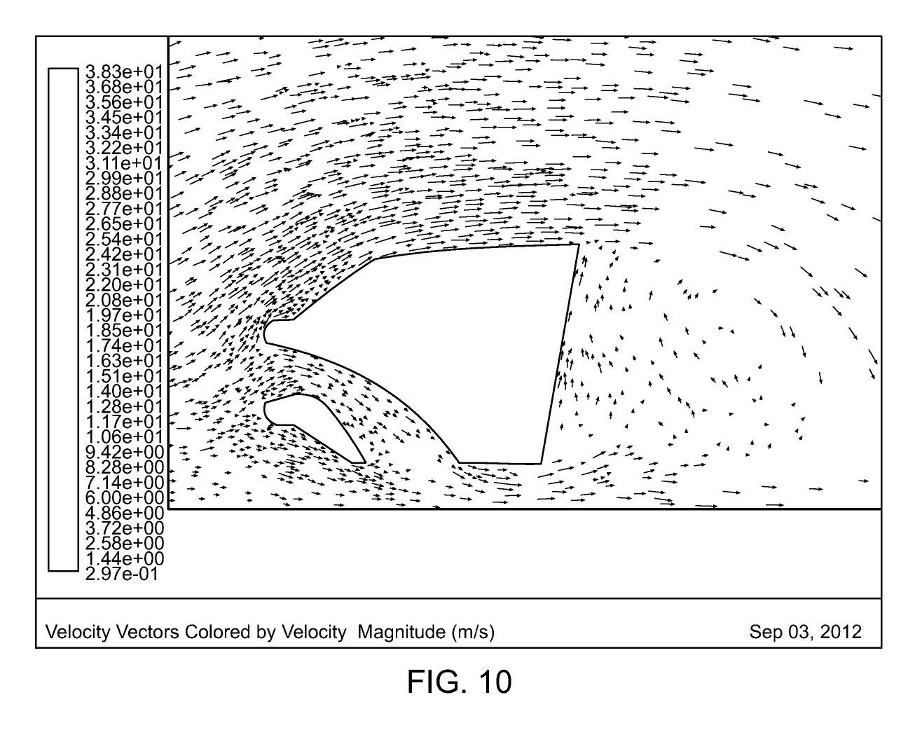

FIGS. 5-10 show a turbo fan generator which generator which may be attached, for example to an automobile bumper, with an intake facing forward and an output end directed toward a fan. The axle of the fan will be attached to a small generator. The calculated torque for a car speed between 37-40 mph is 0.2017 Nm. This particular regen system was never used. This is a new idea which gives enough regen electricity for any moving vehicle or object which can go with that range of speed. Everything is a new design with a special prop design in a way that the turbine can efficiently use the wind. This can also be attached to an electric wind turbine. All of the parts and components are made out of carbon fiber. Currently, energy for accessories comes out of the main battery which lowers the range of the vehicle. Two or three of the WTs can be installed on certain vehicles. The WT is calculated in a way that does not influence the aerodynamics. A second battery, regenerated using a turbo fan, powers accessories so as to reduce the demands on the primary battery.

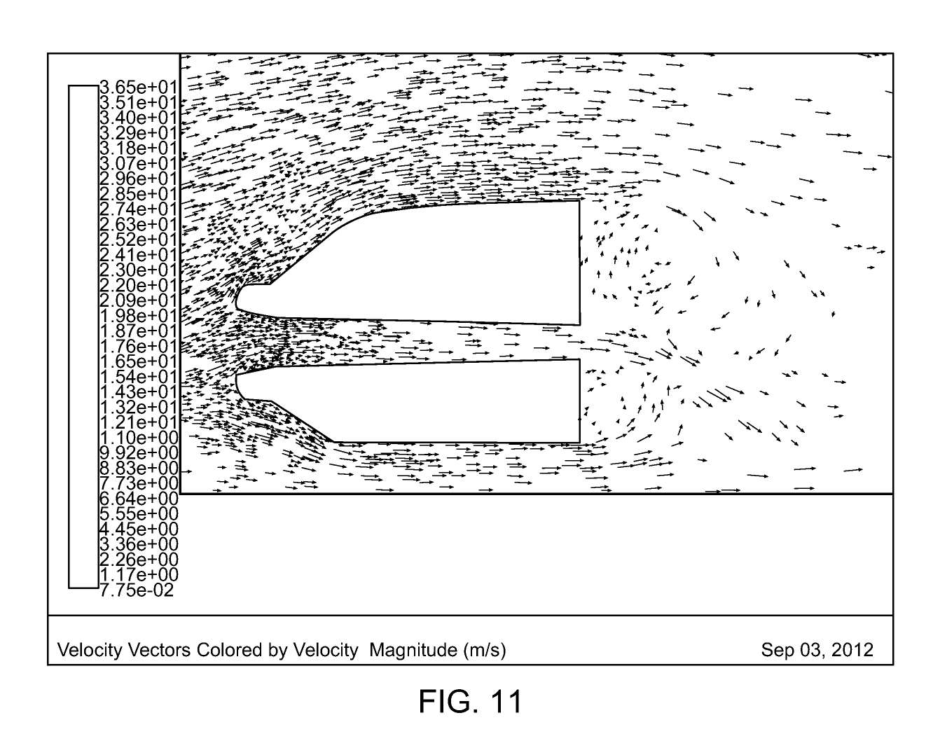

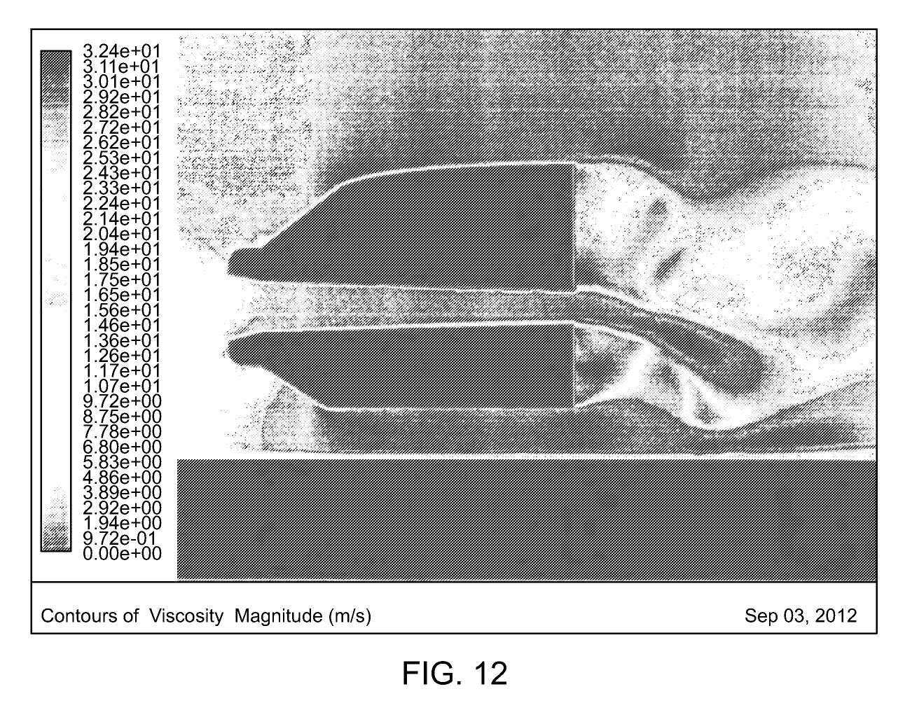

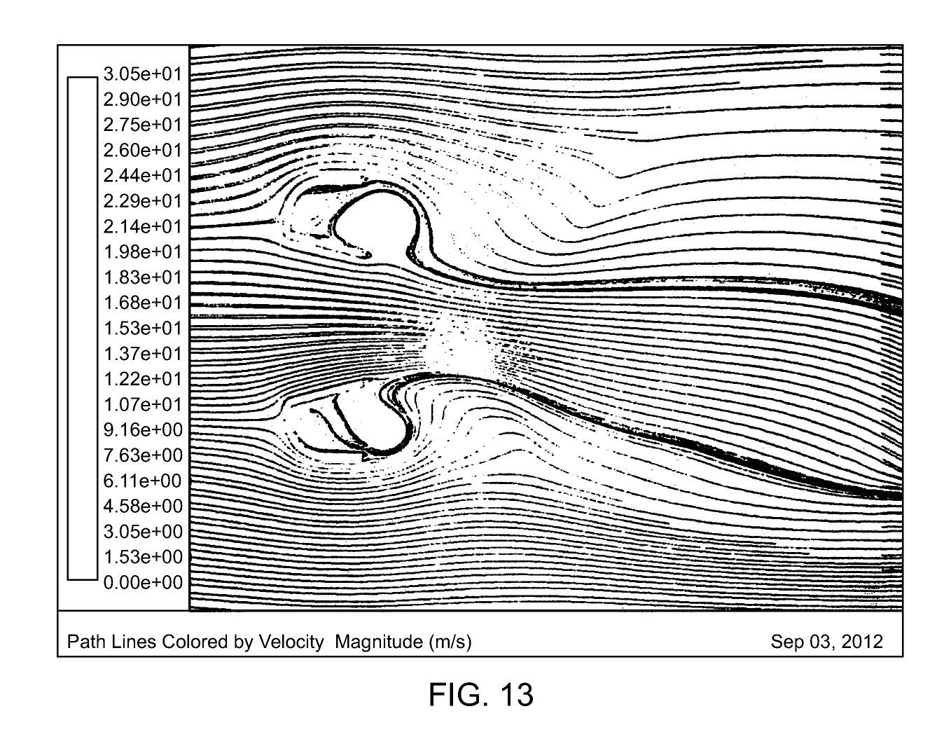

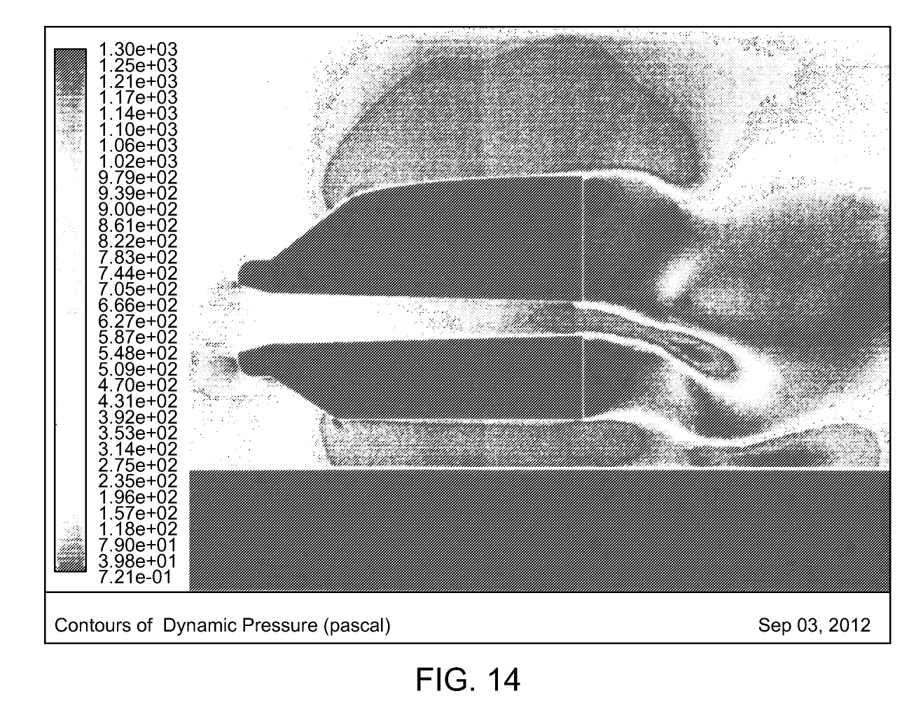

Results of a wind tunnel test of the system are shown in FIGS. 11-25.

### Enhanced Torque Motor System

The invention described and claimed herein comprises a novel system for increasing the torque of an electric motor. Increasing the torque of a motor can provide several advantages in appropriate circumstances. A higher torque motor can deliver more power than a comparable motor with lower torque at the same speed (RPM) or can deliver the same power as a comparable motor with lower torque at lower RPM. Thus, a higher torque motor is capable of changing speed more rapidly than a similar lower torque motor. The torque of a motor can be increased by increasing the size or weight of the motor's rotor.

In addition, a motor rotor rotating at a lower speed can produce a lower level of vibration, which is an advantage in applications where vibration is undesirable, for example in situations where vibration might cause parts to become loose, or where vibrations might produce objectionable noise. Finally, rotating at a lower speed would reduce the gyroscopic effect, thereby allowing a vehicle carrying such a motor to turn more easily.

An enhanced torque motor means a motor which is comparable to a similar motor except that it has higher torque. It would be desirable to have an enhanced torque motor which did not weigh substantially more than its unenhanced counterpart. One advantage of such a motor would be its ability to provide more power at the same speed. Another advantage would be its ability to deliver the same power at lower speed. Another advantage would be reduced vibration.

It is an object of the invention to provide an enhanced torque motor. A feature of the invention is the inclusion of magnets in the motor so as to provide additional torque without substantially increasing the size or weight of the motor.

The invention includes a novel system for enhancing the torque of a motor without increasing the weight or size of the motor to the point where the increase has a significant impact on the device with which the motor is being used.

An enhanced torque motor may be constructed by inserting magnets in the rotor of a motor. Preferably, the magnets would be uniform in dimensions, weight and magnetic flux, and would be uniformly distributed radially around the rotor. The greater the ratio of magnetic flux to weight, the greater the potential enhancement of torque at the same weight. Therefore, powerful magnets are to be preferred and rare earth magnets are especially suitable.

An application which would make particularly good use of the qualities of an enhanced torque motor would be in an electric vehicle. In such vehicles, management of power is extremely important and a significant portion of the available charge on the vehicle's battery is used in vehicle acceleration. An enhanced torque motor should provide the same acceleration as a comparable but unenhanced motor but run at a lower speed. This translates into a reduction in power consumption and therefore longer battery life, a critical factor in the usefulness of an electric vehicle.

While illustrated with respect to use in an electric vehicle, the invention would be of use in any application where enhanced torque is desirable but weight and size must be constrained.

While a specific embodiment of the invention has been shown and described in detail to illustrate the application of the principles of the invention, it will be understood that the invention may be embodied otherwise without departing from such principles and that various modifications, alternate constructions, and equivalents will occur to those skilled in the art given the benefit of this disclosure.

What is claimed is:

1. A system for managing an electrical battery, comprising cells organized into 2 banks;
a monitoring system connected to each of said banks and to means for measuring the remaining charge in each of said banks;
means for selecting at least one bank from among the available banks as a bank which will provide electric power;
means for selecting at least one bank from among the available banks as a bank that will be recharged;
means for storing a preselected critical value;
means for causing a bank then providing power to be deselected as a bank providing power and selected as a bank to be recharged upon reaching the critical value; and
means for causing a bank then being recharged to a point above the critical value to be deselected as a bank to be recharged and selected as a bank providing power.

2. An enhanced-safety electric battery system comprising:
a plurality of cells, battery management, connectors between the cells and an electronic impulse switch.

3. An enhanced torque motor comprising a rotor comprising a face plate attached to a spindle, said spindle passing through and free to rotate within a housing, said face plate having a series of magnets uniformly radially embedded therein.

4. A Sodium Nickel Chloride (NaNiCl) battery giving a nominal operation cell voltage of 2.58 Volts, having cathodes made from NaAlCl4 (sodium chloroaluminate) and anodes made from BASE (sodium beta alumina electrolyte) and sodium anode with a metal chloride; and an electrolyte comprising a mixture of molten compound comprising approximately 38% sodium chloride, 20% nickel, 4% silver, 16% copper, 18% iron.

5. A Sodium Nickel Chloride (NaNiCl) battery as in claim 4 further comprising titanate substrate.
